(19) United States
(12) Patent Application Publication
(10) Pub. No.: US 2012/0248870 A1
(43) Pub. Date: Oct. 4, 2012

(54) BATTERY CHARGER AND METHOD USING AN IRREGULAR POWER SOURCE

(76) Inventors: Julian Coleman, London (GB); Patrick McDougall, London (GB); Matthew Bucknall, London (GB)

(21) Appl. No.: 13/437,030

(22) Filed: Apr. 2, 2012

(30) Foreign Application Priority Data
Mar. 31, 2011 (GB) 1105464.0

(51) Int. Cl. H02J 7/34; H02J 7/00

(52) U.S. Cl. 307/48; 320/107; 320/101; 320/162; 320/150

(57) ABSTRACT

A battery charger includes an irregular power source, a capacitor connected to the power source for storing charge from the power source, and a control circuit which is operable to detect a charge current of a battery to be charged and to discharge the charge from the capacitor into the battery when the charge in the capacitor reaches a predetermined level. The control circuit is configured to change the predetermined level from a bulk charge mode to a float charge mode when the charge current is at or below a threshold value.

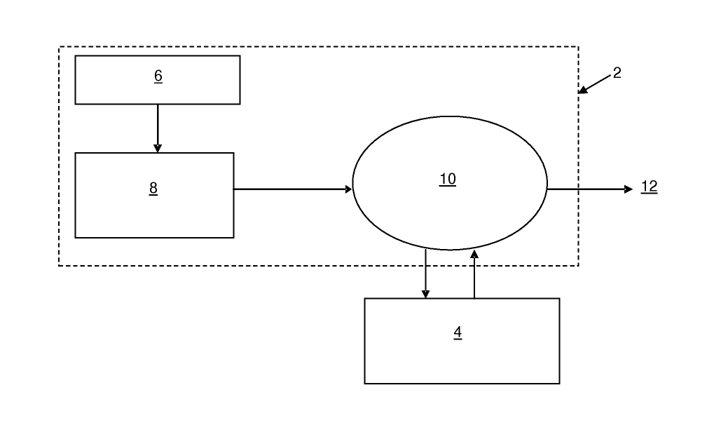

### BACKGROUND OF THE INVENTION

The present invention relates to a battery charger and method which use a power source with a fluctuating or otherwise irregular output.

Various types of battery charger and charge routines are known. Typically, lead acid batteries may be charged using a charge routine that comprises a number of different stages. For example, in an initial charging stage the battery charger may operate in a bulk charge mode. The bulk charge mode is a fast charge process that applies an excess fixed voltage to the battery, usually of about 2.35 V/cell. During the bulk charge stage, the current is limited to a safe level. For example, the charge current may be limited to C/4—where C is the capacity of the battery.

The charge current will reduce as the battery is charged. When the current reduces to C/20, the battery is defined as charged and the charger switches to a second or subsequent stage. In this stage, the charger operates in a float charge mode, where a lower ‘float’ voltage is supplied to the battery. The float charge mode has the advantage that it uses a voltage which is sufficiently low so as to prevent damage to the battery, even when maintained for prolonged periods. Additional stages may be employed in the charging routine, such as a topping charge stage, however these will not be discussed here. Such a multistage charge routine protects the battery from damage and also ensures that the battery is optimally charged both in terms of capacity and efficiency.

It is also known to charge a battery using a renewable power source, such as a solar panel. However, batteries are designed to be charged from a reliable and adequate power supply using a well defined charging routine as described above. In contrast, renewable power sources fluctuate greatly and may not be able to consistently supply sufficient power to carry out such a charging routine.

For example, a battery with a capacity of 100 AHr should be bulk charged at around 25 A when nominally discharged.

As described previously, the point at which the charge cycle must switch to float mode is usually defined by when the current delivered by the (voltage limited) charger falls to C/20. For the above battery, this is 5 A. A 100 W solar panel is able to exceed this figure, but only on relatively rare occasions in good conditions.

EU studies rate a 100 W panel as able to deliver approx 500 WHrs per day of energy in London at the height of summer. Assuming 16 hours of useful daylight this averages at 500/(16*14)=2.23A. Therefore, even on the best of days, for at least half of the day the panel will not produce enough charge to achieve the C/20 critical point.

This is important because unless the charge routine can reliably deliver at the very least C/20 in bulk mode, it is impossible to tell if the battery is actually fully charged.

Consider a constant current delivery of say C/50. It is clear that the battery will eventually be charged (in about 70 Hrs). But no electronic circuit that attempts to conform to the bulk charge routine will ever be able to recognize that fact as C/20 is never reached and so the current flow will always be below the designated threshold value. Hence the charger is nominally in bulk mode, it will remain in bulk mode forever. This is likely to damage the battery since once the battery is fully charged, the charger will continue to pump energy into the battery causing sulphation of the plates and loss of electrolyte, both of which reduce the battery's capacity and longevity.

Many systems make no attempt to mitigate this problem and just accept limited battery life. This may be acceptable for large batteries and very small solar panels as the overcharge effect can be tolerated for a while.

Some chargers attempt to monitor charge applied versus battery drain. This can be effective but, unless further algorithms are applied, is dependent on battery health and a knowledge of the history of the battery. For example, if the battery is removed to perform another task outside the monitoring of the circuit, the knowledge of the past charging regime will be lost. Furthermore, such a circuit does not apply the standard bulk charge routine and consequently may not be optimally efficient.

Alternatively, a taper charge may be used where the charge current is reduced over time. However, with such a routine the system does not use all of the available charge power since any excess power is dumped to ensure that the charge routine does not overcharge the battery.

It is therefore desirable to provide a battery charger and method of charging a battery which is able to utilize all of the power from an irregular power source, such as a renewable power source, but which ensures that it is possible to detect when the battery is charged so as to avoid damaging the battery.

### SUMMARY OF THE INVENTION

In accordance with an aspect of the invention, there is provided a battery charger comprising: an irregular power source; a capacitor connected to the power source for storing charge from the power source; and a control circuit which is operable to detect a charge current of a battery to be charged and to discharge the charge from the capacitor into the battery when the charge in the capacitor reaches a predetermined level; wherein the control circuit is configured to change the predetermined level from a bulk charge mode to a float charge mode when the charge current is at or below a threshold value.

The battery may be a lead-acid battery, particularly a gel type battery. Such batteries are low cost, and provide long life and high storage density.

The capacitor may be a super-capacitor. Using super-capacitors may reduce the losses associated with charging and discharging the capacitors to almost negligible amounts. The circuitry of the invention has been measured to be between 88% and 90% efficient.

The threshold value for the charge current may be C/20.

The power source may be a solar panel, wind turbine and/or water turbine, or other irregular source.

The capacitor may be connected to the power source via a power supply which matches the power source voltage to the voltage required by the capacitor.

The power supply may be a switch mode power supply or other similar unit.

The capacitor is configured to provide a load resistance which corresponds to the maximum power point of the power source.

The capacitor may be configured to operate in a narrow voltage range so as to maintain the power source at or close to the maximum power point. In this regard, one or more capacitors having a high total capacitance may be used in order to allow the required charge to be outputted to the battery with only a small drop in the voltage of the capacitors. Accordingly, super-capacitors are particularly well suited to this application.

The battery charger may further comprise a maximum power point tracker.

The charge management circuit is configured so as to ensure that the power source, such as solar panels, is maintained at, or close to, its maximum power point thus optimizing the efficiency of the power source.

An output load may be powered by the power source when the power source provides sufficient power to do so and may be powered by the battery when the power source provides insufficient power.

The battery charger may further comprise: a temperature sensor for sensing the temperature of the battery; and temperature compensation means for adjusting the voltage of the bulk and/or float charge modes based on the temperature of the battery. Where additional charging stages are used, the temperature compensation means may also adjust the voltage of these stages accordingly.

In accordance with another aspect of the invention, there is provided a method of charging a battery using an irregular power source, the method comprising: charging a capacitor using the power source; detecting a charge current of a battery to be charged; and discharging the capacitor into the battery when the charge in the capacitor reaches a predetermined level; wherein the predetermined level is changed from a bulk charge mode to a float charge mode when the charge current is at or below a threshold value.

The capacitor may be a super-capacitor.

The threshold value for the charge current may be C/20.

The power source may be a solar panel, wind turbine and/or water turbine.

The energy storage device may be configured to provide a load resistance which corresponds to the maximum power point of the power source.

The method may further comprise tracking the maximum power point of the power source and adjusting the load resistance provided by the energy storage device.

The method may further comprise powering an output load using the power source when the power source provides sufficient power to do so and powering the output load using the battery when the power source provides insufficient power.

The method may further comprise: detecting a temperature of the battery; and adjusting the voltage of the bulk and/or float charge modes based on the temperature of the battery.

In accordance with another aspect of the invention, there is provided a battery charger comprising an irregular power source; an energy storage device coupled to the power source for storing energy produced by the power source; and a control circuit which is operable to detect a charge current of a battery to be charged and to output the energy from the energy storage device into the battery when the energy in the energy storage device reaches a predetermined level; wherein the control circuit is configured to change the predetermined level from a bulk charge mode to a float charge mode when the charge current is at or below a threshold value.

In accordance with another aspect of the invention, there is provided a method of charging a battery using an irregular power source, the method comprising: storing energy produced by the power source in an energy storage device; detecting a charge current of a battery to be charged; and outputting the energy from the energy storage device into the battery when the energy in the energy storage device reaches a predetermined level; wherein the predetermined level is changed from a bulk charge mode to a float charge mode when the charge current is at or below a threshold value.

The battery charger and method of the present invention may ensure that power from the power source is not wasted unless the attached systems are fully charged. Furthermore, the present invention ensures that the charge rate never damages the attached battery, but provides a charge routine which is always within the manufacturer's specification for optimum charge.

Various aspects of this invention will become apparent to those skilled in the art from the following detailed description of the preferred embodiment, when read in light of the accompanying drawings.

### BRIEF DESCRIPTION OF THE DRAWINGS

The sole FIGURE is a schematic view of an embodiment of a battery charger.

### DETAILED DESCRIPTION OF THE PREFERRED EMBODIMENT

With reference to the sole FIGURE, a battery charger 2 according to an embodiment of the invention is used to charge a battery 4. The battery 4 may be a lead-acid battery, particularly a gel type battery.

The battery charger 2 is powered by an irregular power source 6. By “irregular” it is meant that the power source is unable to supply a constant power and thus may fluctuate from the desired charge current. Additionally, it may not have sufficient capacity so as to be able to deliver sufficient power to support bulk charge requirements. For example, the power source 6 may be a renewable power source such as a solar panel, wind turbine, water turbine, or a combination of such sources.

The current from the power source 6 is channeled into one or more capacitors 8 which store the charge from the power source 6. The capacitors 8 are preferably super-capacitors. Using super-capacitors reduces the losses associated with charging and discharging to almost negligible amounts.

The capacity of the capacitors 8 is sufficient to store enough charge so as to be able to supply a current which exceeds the threshold value where the charge routine changes from bulk charge mode to float charge mode. The threshold value may be set at a specific value depending on the circumstances, however, as described previously, this is typically C/20. Therefore, when the capacitors 8 are fully charged they are able to supply a current which is at least equal to the threshold value. More specifically, the capacitors 8 are selected to have sufficient charge capacity in order to deliver enough energy to the battery to achieve the bulk charge voltage and (if the battery is full) for the current then to drop to C/20. The measurement of the current is made after sufficient time to enable the internal resistance of the battery 4 to settle and provide an accurate measurement. Accordingly, the charge level is a function of both battery capacity and capacitance of the capacitors 8.

The capacitors 8 are selected to provide a load resistance which corresponds to the maximum power point of the power source 6. This maximizes the power output from the power source 6. In addition, a maximum power point tracker circuit (not shown) may be provided to adjust the load resistance presented to the power source 6 in response to changes in the operating conditions of the power source 6. For example, where the power source 6 is a solar panel, the power point tracker circuit may adjust the resistance based on the temperature of the solar panel, illumination received at the solar panel, and other operating conditions.

The capacitors 8 must be large enough such that the required charge is available when the capacitors 8 are charged just above the maximum power point of the power source 6 and such that, when the charge is used for charging the battery 4, the desired effect is achieved when the capacitors 8 drop to just below the maximum power point. Hence, the power source 6 (e.g. solar) input voltage is maintained at around the maximum power point.

In this regard, the capacitors 8 are configured to operate in a narrow voltage range so as to maintain the power source 6 at or close to the maximum power point at all times. Using capacitors 8 with a high total capacitance allows the required charge to be outputted to the battery 4 with only a small drop in the voltage of the capacitors 8. Accordingly, super-capacitors are particularly well suited to this application.

As an alternative, a switch mode power supply or similar unit (not shown) may be used to match the power source voltage to the voltage required by the capacitor array.

The capacitors 8 are connected to the battery 4 via a control circuit 10. The control circuit 10 controls the charging and discharging of the capacitors 8 in order to provide the required charge current to the battery 4.

When sufficient charge has built up in the capacitors 8, the control circuit 10 uses the available charge to bulk charge the battery 4.

After discharging the capacitors 8 into the battery 4, if the charge current remains above C/20, the control circuit 10 recognizes that the battery is not yet fully charged and so repeats the cycle.

However, if the battery charge current drops to C/20 during the cycle, the control circuit recognizes that the battery is now charged and thus switches from bulk charge mode to float charge mode.

The control circuit 10 also detects when the battery has been drained of some power, for example, as a result of powering an output load 12. In response, the control circuit 10 uses any available power from the power source 6 and capacitors 8 to recharge it. This control circuit 10 recognizes the condition when the charge circuit cannot maintain the float charge voltage from the power source 6. Under these circumstances the battery must be providing output power. Hence, as and when sufficient charge is once again available in the capacitors 8, the control circuit 10 charges the battery 4 in bulk charge mode.

The battery charger is configured using a simple diode or circuit to ensure that the power source 6 is used to power the output load 12 whenever the power source 6 provides sufficient power to do so. Accordingly, the output load 12 is only powered by the battery 4 when the power source 6 provides insufficient power. Furthermore, the battery 4 is only charged when the power source 6 provides insufficient power to power the output load 12 since this is the only time when power is drained from the battery 4.

A temperature sensor (not shown) may also be provided for sensing the temperature of the battery 4. Furthermore, temperature compensation means may adjust the voltage of the bulk and/or float charge modes based on the temperature of the battery 4 so as to maintain the most appropriate voltages for the current conditions of the battery 4.

Although, the charge from the power source 6 has been described as being stored in capacitors 8, other energy storage devices could be used. For example, the energy from the power source 6 may be stored in Superconducting Magnetic Energy Storage (SMES), a thermal battery, a spring, a flywheel, using compressed air or by moving a liquid to impart potential energy.

The present invention is particularly useful in remote situations where a regular power source cannot be used to charge a battery or, indeed, power an output load. For example, the invention may be used to provide transport or other information to remote sites using signage, as described in European Application No. 10177244.0.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A battery charger comprising:
an irregular power source;
a capacitor connected to the power source for storing charge from the power source; and
a control circuit which is operable to detect a charge current of a battery to be charged and to discharge the charge from the capacitor into the battery when the charge in the capacitor reaches a predetermined level;
wherein the control circuit is configured to change the predetermined level from a bulk charge mode to a float charge mode when the charge current is at or below a threshold value.

2. A battery charger as claimed in claim 1, wherein the capacitor is a super-capacitor.

3. A battery charger as claimed in claim 1, wherein the threshold value for the charge current is C/20.

4. A battery charger as claimed in claim 1, wherein the power source is a solar panel, wind turbine and/or water turbine.

5. A battery charger as claimed in claim 1, wherein the capacitor is connected to the power source via a power supply which matches the power source voltage to the voltage required by the capacitor.

6. A battery charger as claimed in claim 5, wherein the power supply is a switch mode power supply.

7. A battery charger as claimed in claim 1, wherein the capacitor is configured to provide a load resistance which corresponds to the maximum power point of the power source.

8. A battery charger as claimed in claim 7, further comprising a maximum power point tracker.

9. A battery charger as claimed in claim 1, wherein an output load is powered by the power source when the power source provides sufficient power to do so and is powered by the battery when the power source provides insufficient power.

10. A battery charger as claimed in claim 1, further comprising: a temperature sensor for sensing the temperature of the battery; and temperature compensation means for adjusting the voltage of the bulk and/or float charge modes based on the temperature of the battery.

11. A method of charging a battery using an irregular power source, the method comprising:
charging a capacitor using the power source;
detecting a charge current of a battery to be charged; and
discharging the capacitor into the battery when the charge in the capacitor reaches a predetermined level;
wherein the predetermined level is changed from a bulk charge mode to a float charge mode when the charge current is at or below a threshold value.

12. A method as claimed in claim 11, wherein the capacitor is a super-capacitor.

13. A method as claimed in claim 11, wherein the threshold value for the charge current is C/20.

14. A method as claimed in claim 11, wherein the power source is a solar panel, wind turbine and/or water turbine.

15. A method as claimed in claim 11, wherein the capacitor is configured to provide a load resistance which corresponds to the maximum power point of the power source.

16. A method as claimed in claim 15, further comprising tracking the maximum power point of the power source and adjusting the load resistance provided by the energy storage device.

17. A method as claimed in claim 11, further comprising powering an output load using the power source when the power source provides sufficient power to do so and powering the output load using the battery when the power source provides insufficient power.

18. A method as claimed in claim 11, further comprising: detecting a temperature of the battery; and adjusting the voltage of the bulk and/or float charge modes based on the temperature of the battery.
